(19) United States
(12) Patent Application Publication
(10) Pub. No.: US 2024/0073064 A1
(43) Pub. Date: Feb. 29, 2024

(54) METHOD OF ESTIMATING THE NUMBER OF CHANNEL TAPS AND CHANNEL COEFFICIENTS IN A CONCATENATED WAY

(71) Applicant: ISTANBUL MEDIPOL UNIVERSITESI, Istanbul (TR)

(72) Inventors: Hüseyin ARSLAN, Beykoz, Istanbul (TR); Mehmet Ali AYGÜL, Beykoz, Istanbul (TR)

(21) Appl. No.: 18/259,853

(22) PCT Filed: Dec. 26, 2021
(86) PCT No.: PCT/TR2021/051515

§ 371 Date: Jun. 29, 2023

(30) Foreign Application Priority Data
Dec. 31, 2020 (TR) 2020/22844

(51) Int. Cl. H04L 25/02

(52) U.S. Cl. CPC H04L 25/0254

(57) ABSTRACT

Disclosed is method of estimating the number of channel taps and channel coefficients in a concatenated way in order for the signal transmitted to be received successfully in the receiver in wireless communication systems. In particular, disclosed is a model that learns the number of channel taps and channel coefficients in a concatenated way in order to benefit from the existing correlation between the number of channel taps and channel coefficients. This model is based on a deep learning-based algorithm.

### TECHNICAL FIELD

The invention relates to the method of estimating the number of channel taps and channel coefficients in a concatenated way in order for the signal transmitted to be received successfully in the receiver in wireless communication systems.

In particular, the invention proposes a model that learns the number of channel taps and channel coefficients in a concatenated way in order to benefit from the existing correlation between the number of channel taps and channel coefficients. This model is based on a deep learning-based algorithm.

### STATE OF THE ART

Channel estimation must be made in order for the signal transmitted to be received successfully in the receiver in wireless communication systems. Channel estimation is a very challenging problem, especially when the channel changes quickly. In addition, if there is a priori information about the number of media and channel taps, it is necessary to find the number of channel taps and then channel coefficients. This two-stage process is carried out using different methods in the literature. However, finding the number of channel taps firstly and then finding the channel coefficients causes the correlation between the number of existing channel taps and the channel coefficient to be neglected.

The current literature first estimates the number of channel taps and then estimates the channel coefficients according to the number of channel taps. Two main methods were used to estimate the number of channel taps in the literature. These are Akaike Information Criterion (AIC) and Bayesian Information Criterion (BIC). The AIC technique generally works with the tendency to find more channel taps than usual (overmodel). This causes a noisy channel estimation to be made. On the other hand, BIC is trying to estimate the number of channel taps in a way that is less than normal (undermodel). The deep learning model has been proposed in [1] and [2] as an alternative to these methods. This deep learning model uses the signals sent and received as input while learning channel coefficients, and only the number of channel taps as output. It trains the machine with these datasets during the training stage and estimates the number of channel taps according to the signal received and given during the test stage. However, only outputting the number of channel taps to the machine will slow down the learning speed of the machine. In addition, the machine will have difficulty in establishing a relationship between the sent and the transmitted signal. This will reduce the performance of the number of channel taps estimation process. In addition, incorrect estimation of the number of channel taps will naturally cause the channel coefficients to be found incorrectly.

### REFERENCES

[1] Kablosuz Haberleşmede Kanal Kademe Numaralanmn Gözü Kapal₁ Tammlanmas₁, Turkish Patent Institute (TPE) Patent Pending, File No: TR2019/22365.
[2] Jaradat, A. M., Elgammal, K. W., Ozdemir, M. K., & Arslan, H. (2020). Identification of The Number of Wireless Channel Taps Using Deep Neural Networks. arXiv preprint arXiv:2010.10193.

In conclusion, it was deemed necessary to make an improvement in the relevant technical field due to the disadvantages described above and the inadequacy of the existing solutions on the subject.

### OBJECT OF THE INVENTION

The object of the invention is to provide a structure having different technical features that are novel in this field, different from the embodiments used in the known state of art.

The primary object of the invention is to greatly increase the success of the number of channel taps and channel coefficient estimation thanks to the concatenated learning of the number of channel taps and channel coefficients, and to reduce the complexity.

The advantages of the invention are listed below.
It increases both the number of channel taps and channel coefficient estimation performance since it establishes a relationship between the number of channel taps and channel coefficient.
The machine establishes the relationship quickly and shortens the time spent in the training of the system since there is more information in the dataset.
It increases spectral efficiency by reducing the number of known symbols (pilots) to be used in the receiver by preventing the channel from being represented by a large number of taps.
The process performed in two steps in the literature (estimation of the number of channel taps and estimation of the channel coefficients) will be carried out in a single stage.

The invention is a method that enables the number of channel taps and channel coefficients to be found in a concatenated way in wireless communication systems in order to achieve the objects described above, characterized in the it comprises the following steps:
a. Finding the maximum possible number of channel taps,
b. Determining whether the total number of channel taps in the training set is less than or greater than or equal to the maximum possible number of channel taps,
c. If the total number of channel taps in the training set is less than the maximum possible number of channel taps, writing 0 to the coefficients of the missing channel taps, if not, taking no action, repeating this process and creating the dataset,
d. Making the learning model learning the number of channel taps and channel coefficients in a concatenated way into a trained learning model by training it using the number of channel taps, channel coefficients, sent signals and received signals,
e. Estimating the number of channel taps and channel coefficients in a concatenated way by giving the sent signals and received signals during the test stage to the trained learning model,
f. Finding out whether the number of channel taps is greater than, less than or equal to the number of channel coefficients found,
g. If the number of channel taps is greater than the channel coefficient found, the greater it is, the higher the value is taken as noise and deleting these noises, taking no action if they are less than or equal to.

The structural and characteristic features and all the advantages of the invention will be understood more clearly by means of the figures and the detailed description with reference to these figures given below and therefore, the evaluation should be made by taking these figures and the detailed description into consideration.

### FIGURES FOR UNDERSTANDING OF THE INVENTION

FIG. 1 is the illustration of the zeroing the unnecessary channel coefficients.

FIG. 2 is a schematic representation of the learning model of the invention.

FIG. 3 shows the removal of the noises from the channel in the machine learning.

FIG. 4 shows a schematic illustration of the training stage in the method of the invention.

FIG. 5 is a schematic illustration of the test stage in the method of the invention.

The drawings are not necessarily drawn to scale and details which are not necessary for the understanding of the present invention may be omitted. In addition, elements that are substantially identical or have substantially identical functions are denoted by the same reference signs.

### DESCRIPTION OF THE PART REFERENCES

10. Example of number of channel taps in training
20. Example of channel coefficients in training
30. Example of signal sent in training
40. Example of signal received in training
50. Learning model
51. Concatenated learning layers of number of channel taps and channel coefficients
52. Only learning layers of number of channel taps
53. Only learning layers of channel coefficients
60. Trained learning model
70. Estimated channel
80. Noise
90. Signal sent in test
100. Signal received in test
110. Estimated number of channel taps
120. Estimated channel coefficients

### DETAILED DESCRIPTION OF THE INVENTION

The preferred embodiments of the invention are merely described for a better understanding of the subject matter and without any limiting effect in this detailed description.

The invention is a method for finding the number of channel taps (10) and channel coefficients (20) in a concatenated way in wireless communication systems and includes the following steps.
1. Creating the training dataset: Vectors or matrices with known real-world number of channel taps (10) and coefficient can be used when creating the training dataset. In addition, the training dataset can be created using Matlab or similar tools with the help of simulations.
2. Preparation of the datasets: After the datasets are created, it is necessary to prepare them in a way that the machine can learn. The signal transmitted by the transmitter and the signals received by the receiver are used when creating channel datasets for input data. These signals can be given in different ways as input to the machine. The following is how these can be input to the machine.
The received and given signals can be concatenated into a vector.
The received signal can be considered as a vector, the given signal can be considered as another vector, and the two signals can be represented by a matrix.
If the received and given signals contain real and virtual values, they can also be expressed by concatenation.

The input can be expressed in different ways as a result. The important thing here is that the sent and transmitted signals are given as input to the machine. In addition, the sent signal (30) is considered the same in some cases. The sent signal (30) may not need to be given to the machine as input in such cases. In other words, if it is known by the receiver that the sent signal (30) is always the same, only the received signal (40) can be given to the machine as input.

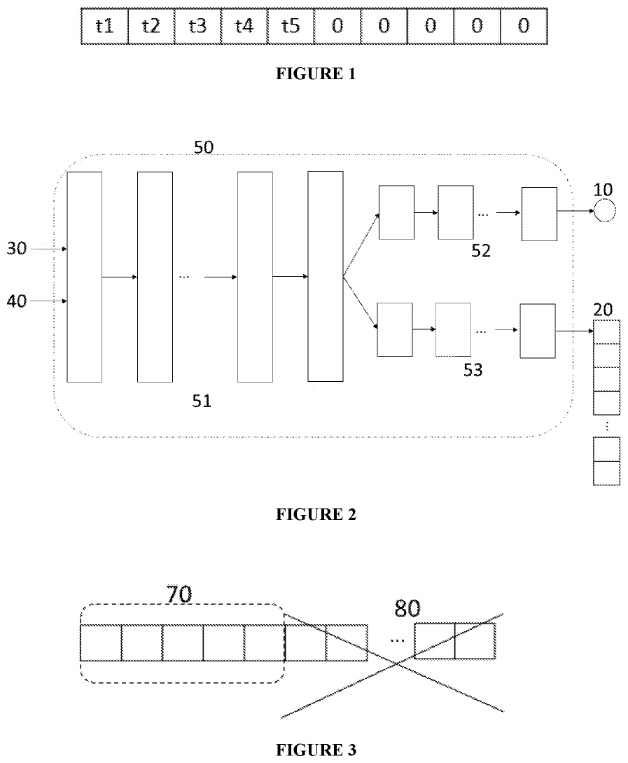

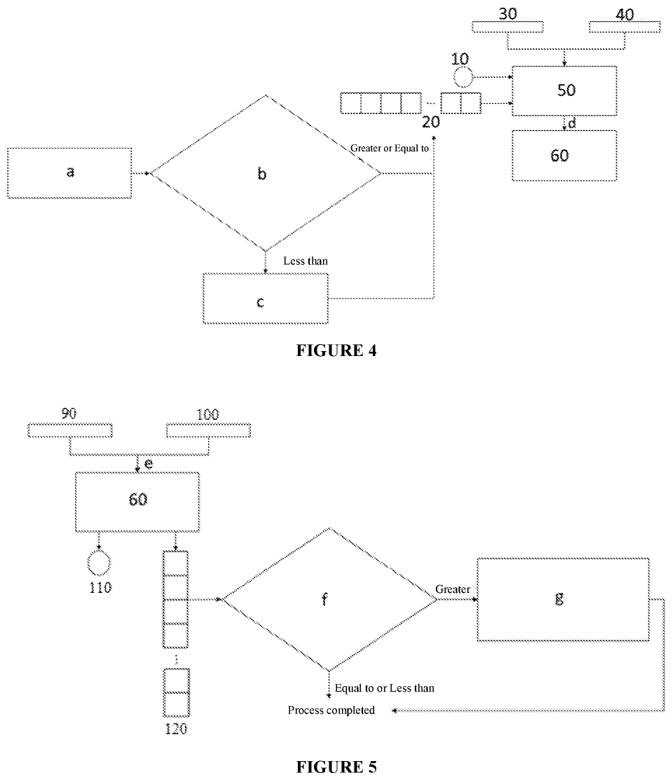

The main stage that distinguishes our invention from the study in [1] is the creation of the output dataset and how to use it in the machine. For example, the study in [1] uses only the dataset number of channel taps (10) as output. This makes the dataset fairly poor and prevents the machine from learning correctly and quickly. Instead, learning both the number of channel taps (10) and channel coefficients (20) simultaneously will greatly improve the performance of the machine. Meanwhile, no additional process is required to find channel coefficients (20) since both the number of channel taps (10) and channel coefficients (20) are found in a single stage. The output dataset can be created in the following steps.
It is necessary to determine the maximum possible number of channel taps. Different ways can be followed for this. For example, if the system is a millimetric wave, the number of channel outputs is generally selected as up to 5, or if the system is an LTE system, the number of channel outputs can be selected as 20, or the largest number of channel taps in the training dataset can be selected as the maximum possible number of channel taps to make the system environmentally sensitive.
If the number of known channel taps (10) in the training stage is less than the maximum number of channel taps we determined in the previous stage, the channel coefficients (20) are written for the known channel taps and “0” is written for the remaining values. A vector of maximum channel coefficient will be formed here as a result. The channel coefficients (20) in the dataset will be written for the channel coefficients (20) that actually exist, while they will take the value of “0” for non-existent values in this vector. The actual number of channel taps (10) is 5 in the example in FIG. 1. However, suppose that the maximum number of channel taps is found as 10 in the previous stage. The first 5 values are written to the channel vector and the remaining values take the value “0”.
A second output will be given the value of the actual number of channel taps to enable the machine to learn quickly and more accurately in addition to the previous stage for finding the channel coefficients (20). The output here is represented in the number of channel taps (10) and channel coefficients (20) part in FIG. 2. Creating the dataset by repeating these processes,
3. Machine design: The machine needs to be designed according to the dataset created after the dataset is prepared. The design of the machine will be prepared in such a way as to keep the performance as high as possible and to be less complex according to the dataset. It is highly preferred in the literature to design the optimum machine according to the loss graph of the training and validation dataset (the validation dataset is explained in the next stage). In other words, the hyper parameters of the machine can be determined accordingly. The machine learning proposed in the invention is given in general terms in FIG. 2 in addition to this. The machine is trained to learn both the number of channel taps (10) and channel coefficients (20) in a concatenated way according to the dataset taken and given in the first layers as seen in FIG. 2. Afterward, only the layers used specifically for the number of channel taps (10) and the channel coefficients (20) make result decisions. The number of layers used here can also be decided by looking at the loss graphs.
4. Obtaining the validation dataset: Sometimes only training and test set is used in machine learning algorithms, sometimes training, validation and test set can be used. The validation test set is highly preferred to determine the optimum machine design and when the training should stop. The validation dataset is the same as the training dataset and can be created in the same way. The validation dataset is half of or less than the training dataset in general.
5. Training the machine: The machine is trained according to the training and validation dataset. Machine learning is stopped when the training and validation set converges.
6. Testing the machine: This stage is the stage where the machine will show its actual performance. The signals are received here. It estimates the number of channel taps (110) and coefficients (120) according to the received signal and known transmitted signals and the machine trained in the training set.
7. Truncation: Two outputs will be obtained as a result of machine learning. These are the vector estimates of the number of channel taps (110) and the channel coefficients (120). The channel vector has a channel coefficient (120) in the maximum number of channel taps created while preparing the dataset of the machine. However, the values after the number of channel taps (110) found detect the noise. For this reason, truncation must be performed. In other words, only the values of the vector of the channel coefficients (120) found up to the number of the obtained channel taps (110) are taken as channels, and the other parts are cut off from the vector. This situation is visualized in FIG. 3. More specifically, the channel obtained in machine learning is equal to the maximum number of channel taps obtained when preparing machine learning according to this figure. Afterward, the excess values were taken as noise and removed from the formed channel vector according to the number of channel taps (110) found in the machine. For example, the machine has found the channel coefficients (120) for 10 taps. However, the number of channel taps (110) was obtained as 5 at the same time. The first 5 channel coefficients (120) were accepted as channels, and the rest were taken as noise for this reason.

The process steps performed in the method of the invention are as follows:
a. Finding the maximum possible number of channel taps,
b. Determining whether the total number of channel taps in the training set is less than or greater than or equal to the maximum possible number of channel taps (10),
c. If the total number of channel taps (10) in the training set is less than the maximum possible number of channel taps, writing 0 to the coefficients of the missing channel taps, if not, taking no action, repeating this process and creating the dataset,
d. Making the learning model (50) learning the number of channel taps (10) and channel coefficients (20) in a concatenated way into a trained learning model (60) by training it using the number of channel taps (10), channel coefficients (20), sent signals (30) and received signals (40),
e. Estimating the number of channel taps (110) and channel coefficients (120) in a concatenated way by giving the sent signals (90) and received signals (100) during the test stage to the trained learning model (60),
f. Finding out whether the estimated number of channel taps (110) is greater than, less than or equal to the number of the channel coefficient (120) found,
g. If the estimated number of channel taps (110) is greater than the channel coefficient (120) found, the greater it is, the higher the value is taken as noise (80) and deleting these noises (80), taking no action if they are less than or equal to (The resulting vector represents the channel).

1. A method that enables the number of channel taps and channel coefficients to be found in a concatenated way in wireless communication systems, comprising the following steps:
finding the maximum possible number of channel taps;
determining whether the total number of channel taps in the training set is less than or greater than or equal to the maximum possible number of channel taps;
if the total number of channel taps in the training set is less than the maximum possible number of channel taps, writing 0 to the coefficients of the missing channel taps, if not, taking no action, repeating this process and creating the dataset;
making a learning model learning the number of channel taps and channel coefficients in a concatenated way into a trained learning model by training it using the number of channel taps, channel coefficients, sent signals and received signals;
estimating the number of channel taps and channel coefficients in a concatenated way by giving the sent signals and received signals during the test stage to the trained learning model;
finding out whether the estimated number of channel taps is greater than, less than or equal to the number of the channel coefficient found; and
if the estimated number of channel taps is greater than the channel coefficient found, the greater it is, the higher the value is taken as noise and deleting these noises, taking no action if they are less than or equal to.
